(19) United States
(12) Patent Application Publication
(10) Pub. No.: US 2026/0093692 A1
(43) Pub. Date: Apr. 2, 2026

(54) FOUNDATION MODEL-ASSISTED MULTI-API INTERFACE FOR USER QUERY FULFILLMENT

(71) Applicant: Palo Alto Networks, Inc., Santa Clara, CA (US)

(72) Inventors: Ignacio Nicolas Bermudez Corrales, Oakland, CA (US); Alok Tongaonkar, San Jose, CA (US)

(21) Appl. No.: 18/901,174

(22) Filed: Sep. 30, 2024

(51) Int. Cl. G06F 16/242; G06F 16/25

(52) U.S. Cl. CPC G06F 16/2448; G06F 16/243; G06F 16/252

(57) ABSTRACT

An application programming interface (API) query interface provides an interface between users and products/services having their own respective API by creating API calls based on user queries. The query interface determines which API and corresponding function to call to fulfill a user query based on determined similarities between embeddings of example queries that have been generated across available API functions and an embedding of the user query. The query interface populates the API function with a value(s) of its parameter(s) determined based on the user query, a specification of the API function including accepted parameters, and examples of user queries and corresponding values of the parameters previously determined for the API function. The agent calls the API function populated with its parameter value(s) to obtain an API response and generates a response to the user query based partly on a size of the API response.

### BACKGROUND

The disclosure generally relates to data processing (e.g., CPC subclass G06F) and to computing arrangements based on specific computational models (e.g., CPC subclass G06N).

Rapid developments in artificial intelligence (AI) technologies have spawned numerous terms with fluid meanings. Recently, AI technologies are frequently referred to with the terms large language model (LLM), generative AI, and foundation model. Many of these technologies are based on or relate to the “Transformer” architecture. The Transformer was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a “foundational model.” The Center for Research on Foundation Models at the Stanford Institute for Human-Centered Artificial Intelligence used this term in an article “On the Opportunities and Risks of Foundation Models” to describe a model trained on broad data at scale that is adaptable to a wide range of downstream tasks. There has been subsequent research in similar Transformer-based sequence modeling. The architecture of a Transformer model typically is a neural network with transformer blocks/layers, which include self-attention layers, feed-forward layers, and normalization layers. The Transformer model learns context and meaning by tracking relationships in sequential data.

LLMs have recently seen a surge in use across technology areas. An LLM is “large” because the training parameters are typically in the billions and have been approaching a trillion parameters. AI technologies are not limited to LLMs and research and utilization of “lightweight” language models (i.e., fewer parameters than large) has grown. Language models can be pre-trained to perform general-purpose tasks or tailored to perform specific tasks. Tailoring of language models can be achieved through various techniques, such as prompt engineering and fine-tuning.

### BRIEF DESCRIPTION OF THE DRAWINGS

Embodiments of the disclosure may be better understood by referencing the accompanying drawings.

FIG. 1 is a conceptual diagram of responding to a user query based on selecting a relevant application programming interface (API) function and calling the selected API function.

FIG. 2 is a flowchart of example operations for selecting an API function to invoke as part of fulfilling a user query.

FIG. 3 is a flowchart of example operations for creating an API function call based on a user query.

FIG. 4 is a flowchart of example operations for generating a response to a user query based on an API response.

FIG. 5 depicts an example computer system with an API query interface.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Foundation models, such as LLMs, are often used by organizations as the basis of chatbot technologies provided to users as an interface by which users can interact with the organizations'products or services using queries comprising natural language. These products/services generally have their own application programming interface (API) with a corresponding API specification. Designing workflows for formulating API calls representing user queries that comport to the API specification and can properly be executed is a laborious task, especially due to the wealth of APIs and API functionality that an organization can expose for its associated products/services, so chatbot technologies often are limited in the products/services or API-exposed functionality with which they are compatible.

Disclosed herein is an API query interface between users and various products/services of an organization having their own APIs that creates, based on user queries, API calls that are compatible with an API of one of the products/services to which each user query is determined to be applicable. The disclosed query interface provides expanded coverage and support for converting user queries comprising natural language to API function calls. The query interface determines an API and corresponding function to call to fulfill a user query based on determining similarities between embeddings of example queries that have been generated across available API functions and an embedding of the user query. The example queries are examples of questions that can be answered with each available API function. Once the query interface has selected an API function to call to fulfill a user query, the query interface populates the API function with a value(s) of its parameter(s) determined based on the user query, a specification of the API function including accepted parameters, and examples of user queries and corresponding values of the parameters previously determined for the API function. The query interface calls the API function populated with its parameter value(s) to obtain an API response. If the API response is sufficiently small (e.g., has a size below a threshold), the agent generates a response to the user query based on the obtained response. If the API response is large, the agent preprocesses the results before generating a response to the user query since some of the data included in the API response may not be relevant to the user query, and generating a response to the user query with the collective set of data can incur substantial costs. The agent stores the data of the API response in a data store, which may be instantiated in-memory, and generates a database query representing the user query that it executes against the data store. The executing this query yields a subset of the API response that is relevant to the user query, and from this subset of the API response, the agent generates a response to the user query.

### Example Illustrations

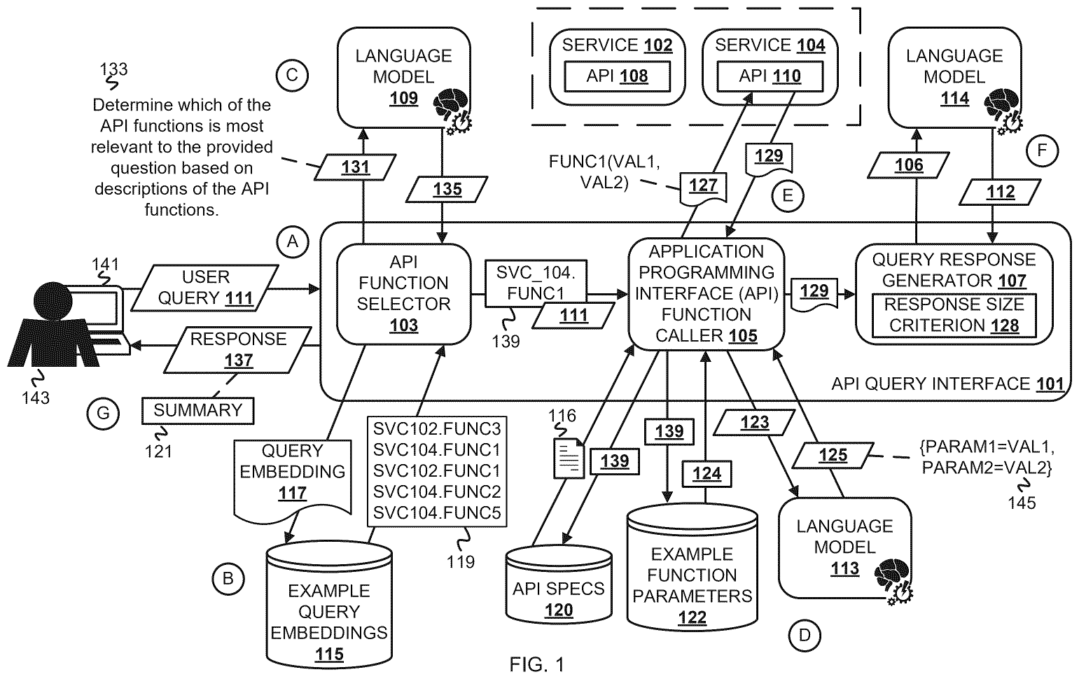

FIG. 1 is a conceptual diagram of responding to a user query based on selecting a relevant API function and calling the selected API function. An API query interface (“query interface”) 101 provides an interface by which users can invoke functionality of various products or services via their APIs through submission of queries comprising natural language. Users can submit queries to the query interface 101 via a chatbot interface. FIG. 1 depicts the query interface 101 as providing an interface for two services as an illustrative example: a service 102 that exposes an API 108, and a service 104 that exposes an API 110. Functionality of each of the services 102, 104 can be invoked via respective ones of the APIs 108, 110. The services 102, 104 can be different services of an organization and may utilize different respective databases (not depicted in FIG. 1) for storage of data retrievable via the respective APIs 108, 110.

FIG. 1 is annotated with a series of letters A-G. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, a user 143 submits a user query 111 to the query interface 101 from a client device 141. The user query 111 comprises natural language. To illustrate, the user 143 can submit the user query 111 to the query interface 101 via a graphical user interface (GUI) comprising a chat interface presented via the client device 141. The query interface 101 obtains the user query 111.

At stage B, an API function selector (“function selector”) 103 of the query interface 101 determines a set of functions of the APIs 108, 110 that are candidates for fulfilling the user query 111. To determine the set of functions, the function selector 103 generates an embedding 117 of the user query 111. The function selector 103 can utilize an open-source and/or off-the-shelf embedding model, such as a word2vec/doc2vec model or a sentence transformer, for generating the embedding 117. The function selector 103 queries a database 115 of example query embeddings with the embedding 117 to find a set of the most similar embeddings to the embedding 117 maintained therein. The database 115 maintains embeddings of example user queries that were previously generated (e.g., based on expert/domain knowledge and/or by utilizing a language model) and, for each example query, a corresponding API function. The API function associated with each example query is the API function that should be invoked to fulfill the example query. API functions that correspond to the example queries represented with embeddings in the database 115 were determined previously based on expert/domain knowledge.

The set of most similar embeddings for which the function selector 103 queries the database 115 can be the N most similar embeddings, where N is a configurable value of the function selector 103, or a set of all embeddings that satisfy a similarity criterion for the embedding 117 (e.g., based on a measure of semantic similarity between text computed based on embeddings, such as a cosine similarity, satisfying a criterion). This example depicts the function selector 103 as determining the five most similar embeddings maintained in the database 115 to the embedding 117. Querying the database 115 for the five most similar embeddings to the embedding 117 yields a set of candidate API functions 119 that correspond to the five most similar embeddings in the database 115. Embeddings corresponding to the candidate API functions 119 are not depicted in FIG. 1 for clarity and to aid in illustration. The candidate API functions 119 comprise example functions “FUNC3” and “FUNC1” of the API 108 exposed by the service 102 and example functions “FUNC1,” FUNC2,” and “FUNC5” of the API 110 exposed by the service 104.

At stage C, the function selector 103 selects one of the candidate API functions 119 based on prompting a language model 109 to determine which of the candidate API functions 119 is most relevant to the user query 111 based on descriptions of the candidate API functions 119. The most relevant API function to the user query 111 is the one of the candidate API functions 119 that is best able to provide information that answers or fulfills the user query 111. The function selector 103 retrieves descriptions of each of the API functions indicated in the candidate API functions 119. The description of an API function is generally the description included in the API documentation to which the function corresponds. Descriptions can include API function parameters and descriptions thereof, return values and a description thereof, etc. The function selector 103 maintains or has access to (e.g., has access to a repository storing API documentation) documentation of the APIs 108, 110 in a standardized format for API documentation, such as OpenAPI Specification, Yet Another Markup Language (YAML), or JavaScript® Object Notation (JSON). In any of these formats, the function selector 103 can extract (e.g., copy) function descriptions stored as values in a respective field/key. The function selector 103 extracts the descriptions of the functions “FUNC3” and “FUNC1” from documentation of the 108 and descriptions of the functions “FUNC1,” FUNC2,“ and “FUNC5” from documentation of the API 110.

The function selector 103 prompts a language model 109 to select one of the candidate API functions 119 that is most related to the user query 111 based on their descriptions. The language model 109 can be an LLM accessible via a respective API for submission of prompts. The function selector 103 generates a prompt 131 that indicates the user query 111, the candidate API functions 119 and their descriptions, and a task instruction 133 to determine which of the candidate API functions 119 is most relevant to the user query 111 based on their descriptions. The function selector 103 may be configured with a prompt template having placeholder fields for a user query and descriptions of candidate API functions, where the function selector 103 inserts the user query 111 and indications of the candidate API functions 119 and their descriptions in the placeholder fields to generate the prompt 131. An overview of an example portion of a prompt template that the function selector 103 can use to generate the prompt 131 is as follows:

“””
Here is a list of API functions and their descriptions:
{FUNC1
description
input fields
output}
{FUNC2
description
input fields
output}
...

From the listing of API functions and their descriptions, select one of the API functions that best answers the question:

Q: {USER_QUESTION}
A:
“ ””

The function selector 103 prompts a language model 109 with the prompt 131 to obtain a response 135 indicating one of the candidate API functions 119. This example assumes that the response 135 obtained from the language model 109 indicates a function 139 “FUNC1” of the service 104 API (i.e., the API 110) as being most relevant to the user query 111.

At stage D, an API function caller (“function caller”) 105 of the query interface 101 determines parameters of the function 139 based on the user query 111. The function caller 105 determines one or more parameters accepted by the function 139 and pairs of example queries and corresponding values of the parameters accepted by the function 139 that have been determined from the example queries as part of determining the parameter values from the user query 111. To determine the parameters accepted by the function 139, the function caller 105 retrieves a specification of the API 110 at least for the function 139 from an API specification repository 120. The function caller 105 can obtain a specification 116 that corresponds to all functions of the API 110 and extract the subset of the specification indicating the function 139 and its parameter(s) and their type(s) from the specification 116 (e.g., based on parsing and/or searching the specification 116). As another example, the function caller 105 can obtain the specification 116 comprising documentation of the function 139 individually based on identifying the function 139 in the query submitted to the API specification repository 120. The function caller 105 can also extract descriptions of the parameter(s) of the function 139 from the specification 116.

To determine the pairs of example queries and corresponding values of the parameters accepted by the function 139, the function caller 105 queries a database 122 that maintains, for each API function supported by the query interface 101, a set of example queries relevant to the API function and values of each parameter of the API function determined based on the example queries. The information maintained in the database 122 has been curated based on expert/domain knowledge, and API function calls represented by the example parameter values maintained therein should have been previously verified to be valid function calls (i.e., can be executed to obtain a valid API response). The function caller 105 queries the database 122 with an indication of the function 139 (i.e., the function name) to obtain the corresponding pairs of example queries and parameter values determined for the function 139.

The function caller 105 then prompts a language model 113 with a prompt 123 that indicates the user query 111, the parameter(s) of the function 139 and optionally descriptions of the parameters extracted from the specification 116, and pairs of example queries and corresponding parameter values of the function 139 obtained from the database 122. The function caller 105 may be configured with a prompt template having placeholder fields for a user query, a specification of an API function, and example queries and corresponding parameter values for the API function, where the function caller 105 inserts the user query 111, the specification that documents the function 139, and the example user queries and corresponding parameter values of the function 139 in the placeholder fields to generate the prompt 123. An overview of an example portion of a prompt template that the function caller 105 can use to generate the prompt 123 is as follows:

“””
Here is a specification of an API function:
{SPECIFICATION}
Given this specification, and examples of questions and query parameters:
{Q: Question1
A: Query1
Q: Question2
A: Query2}
...
If a user asks this question, please complete the Answer based on the
examples using the specification as a reference.
Q: {USER_QUESTION}
A:
“””

The function caller 105 obtains a response 125 to the prompt 123 that comprises parameter values 145, given as example values “val1” and “val2” for respective parameters “param1” and “param2” of the function 139.

At stage E, the function caller 105 calls the function 139 populated with the parameter values 145. The function caller 105 populates the function 139 with the parameter values 145 to create a function call 127 and issues the function call 127 to the service 104 via the function 139 of the API 110. In response to the function call 127, the function caller 105 obtains an API response 129.

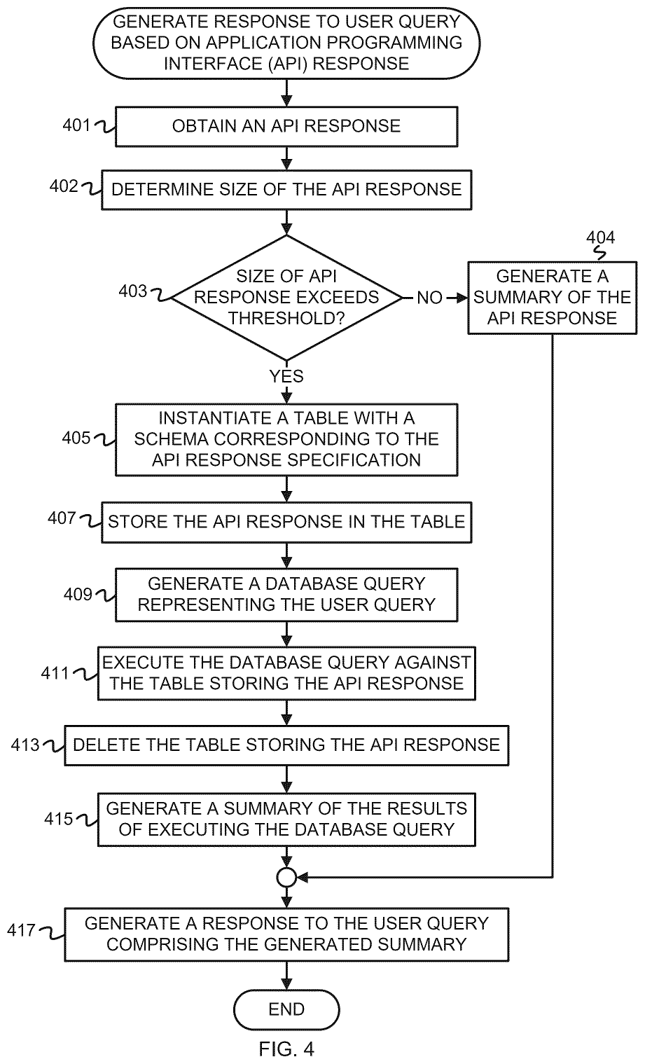

At stage F, a query response generator (“response generator”) 107 of the query interface 101 generates a response to the user query 111 based on the API response 129. The response generator 107 has been configured with a response size criterion (“size criterion”) 128 indicating a criterion for sizes of API responses that inform generation of responses to user queries. The size criterion 128 can be a threshold, where sizes that exceed the threshold are designated as too large for standard response generation. The response generator determines a size of the API response 129 (e.g., based on a response header) and evaluates the size based on the response size criterion. This example assumes that the API response 129 has a size that is considered sufficiently small with respect to the size criterion 128 for standard query response generation, though generation of responses to user queries based on larger API responses is described in further detail in reference to FIG. 4. Based on determining that the API response 129 is sufficiently small, the response generator 107 prompts a language model 114 with a prompt 106 to generate a summary of the API response 129 in natural language. The prompt 106 should comprise the API response 129 and a task instruction to generate a summary of the API response 129 in natural language or to describe the API response 129. The language model 114 responds to the prompt 106 with a response 112 that comprises a summary 121 of the API response 129.

At stage G, the query interface 101 provides a response 137 to the user 143. The response 137 at least comprises the summary 121 of the API response 129. The query interface 101 communicates the response 137 to the client device 141 for presentation to the user 143 (e.g., via the GUI).

In FIG. 1, the language models 109, 113, 114 used for the respective tasks of API function selection, parameter determination, and response generation are depicted as separate language models. In implementations, the query interface 101 can leverage a same or fewer language models for the tasks of API function selection, parameter determination, and response generation and may further chain prompts. Further, the language models 109, 113, 114 can be general-purpose pre-trained models that perform the corresponding tasks indicated in prompts that have been engineered for the specific tasks or can be fine-tuned or otherwise adapted to perform the corresponding tasks.

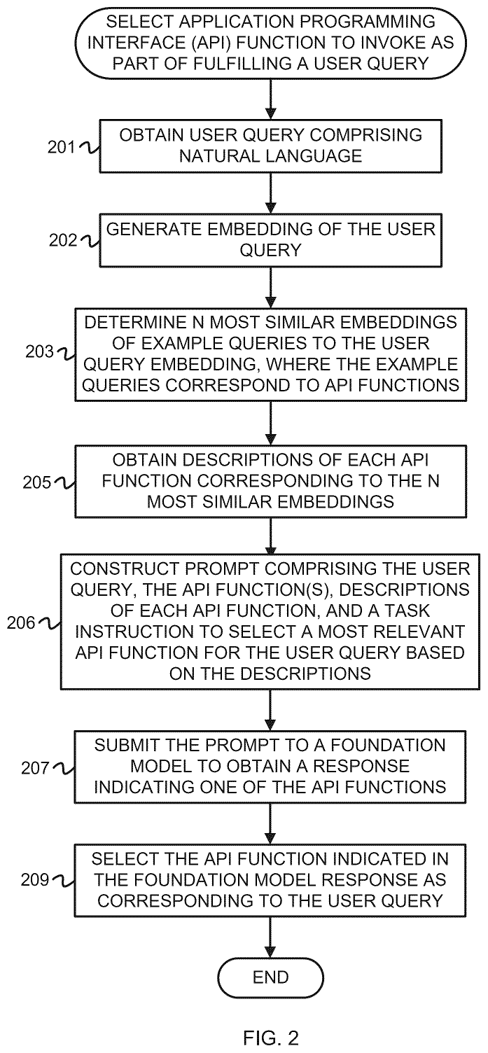

FIGS. 2-4 are flowcharts of example operations. The example operations are described with reference to an API query interface (hereinafter “the query interface”) for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. Some components of the query interface may run locally or be remotely called. In other words, the components of the query interface may be distributed.

FIG. 2 is a flowchart of example operations for selecting an API function to invoke as part of fulfilling a user query. The example operations assume that the query interface can interact with one or more products or services having corresponding APIs. In other words, the query interface can provide an interface for one or more APIs having a corresponding one or more API functions.

At block 201, the query interface obtains a user query comprising natural language. The user query may have been submitted via a chatbot interface. The user query may be a cybersecurity-related question originating from a user such as a network administrator within an organization that utilizes the chatbot interface.

At block 202, the query interface generates an embedding of the user query. The query interface utilizes an embedding model to generate the embedding of the user query, such as a word2vec or doc2vec model, a sentence transformer, etc.

At block 203, the query interface determines a set of N embeddings of example queries most similar to the user query embedding, where each of the example queries corresponds to an API function. The query interface has access to a database maintaining embeddings generated from examples of user queries that correspond to a variety of topics to which the APIs are relevant. Example user queries may have been generated based on expert or domain knowledge and/or with the assistance of a language model prompted to generate a variety of example questions for each API across functions of the API. Each example query embedding maintained in the database is associated with (e.g., via a label/tag) an indication of the API function most relevant to the example query. Determination of which API function is most relevant to each example query is based on expert knowledge/domain knowledge and/or with the assistance of a language model through prompt engineering. The query interface queries the database for the N most similar embeddings to the user query embedding. The N most similar embeddings represent the N most similar example queries to the user query and are associated with one or more of the API functions. Multiple example queries may be defined for a single API function, so multiple ones of the N most similar example queries may correspond to the same API function.

At block 205, the query interface obtains descriptions of each API function corresponding to the N most similar embeddings. Descriptions of the API function(s) can be obtained from respective API documentation defined with the OpenAPI Specification format and/or formatted with YAML, JSON, etc. For instance, the query interface can retrieve the descriptions of the API function(s) by searching a repository(ies) or file(s) that stores API documentation for each respective API.

At block 206, the query interface constructs a prompt comprising the user query, the API function(s) corresponding to the N most similar embeddings, descriptions of each API function, and a task instruction to select a most relevant API function for the user query based on the API function description(s). The query interface can be configured with a prompt template having placeholder fields that the query interface populates with respective ones of the user query and an indication of each of the API functions and corresponding descriptions.

At block 207, the query interface submits the prompt to a foundation model to obtain a response indicating one of the API functions. The foundation model may be a language model (e.g., an LLM) that the query interface can prompt via an API or other interface.

At block 209, the query interface selects the API function indicated in the foundation model's response as corresponding to the user query. The query interface determines that the API function selected by the foundation model is the most relevant API function to the user query.

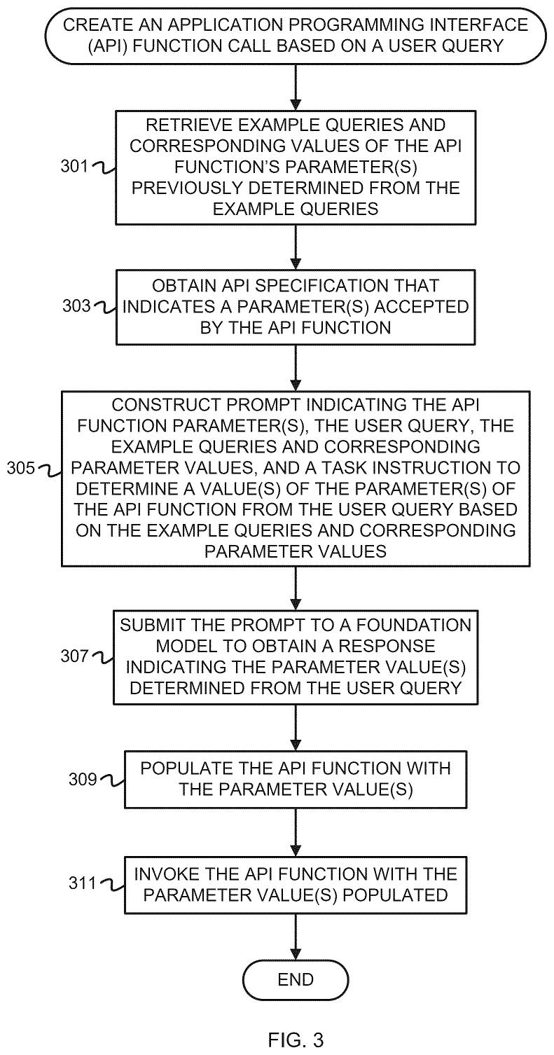

FIG. 3 is a flowchart of example operations for creating an API function call based on a user query. The example operations assume that an API function has already been selected as corresponding to the user query (e.g., as described in reference to FIG. 2).

At block 301, the query interface retrieves example queries and corresponding values of the API function's parameter(s) previously determined from the example queries. The query interface has access to a database that stores, for each available API function, example user queries that can be answered with that API function and a corresponding value for each parameter of the API function, where the parameter value(s) is determined from the example user query. These example user queries and corresponding parameter values have been previously determined based at least partly on domain/expert knowledge and have been verified to be valid API calls that return an API response. The query interface queries the database with the API function to obtain the corresponding set of example queries and parameter values. As an illustrative example of an example query and corresponding parameter values, the example query may be, “What are my active alerts from the last month?”, which has associated parameter values “{status: open, timerange: 1 month}”

At block 303, the query interface obtains a specification of the API that indicates a parameter(s) accepted by the API function. The query interface also has access to a repository(ies) of API documentation for each API with which the query interface is compatible. The API documentation should be in a standard format, such as OpenAPI, YAML, JSON, etc. The query interface can obtain the documentation for the API to which the function corresponds from the respective repository and parse and/or search the retrieved documentation to determine the accepted parameter(s), type(s), and their order (for functions accepting multiple parameters). As another example, the query interface can query the documentation repository with the API function name to obtain a subset of the documentation specific to the API function and determine the API function definition (i.e., the accepted parameter(s), value type(s), and order) from the obtained subset of documentation.

At block 305, the query interface constructs a prompt indicating the API function parameter(s), the user query, the example queries and corresponding parameter values, and a task instruction to determine a value(s) of the parameter(s) of the API function from the user query based on the example queries and corresponding parameter values. The query interface can be configured with a prompt template comprising placeholders for API function definitions, pairs of example queries and parameter values, and a user query and populate the prompt template accordingly. The prompt template can specify that ordering of the parameter values given in the API function definition is important and that, if more than one parameter value is to be determined, the provided order of the parameter values must match the order given in the function definition.

At block 307, the query interface submits the prompt to a foundation model to obtain a response indicating the parameter value(s) determined from the user query. The foundation model may be a language model (e.g., an LLM) that the query interface can prompt via an API or other interface.

At block 309, the query interface populates the API function with the parameter value(s). The query interface identifies the parameter value(s) indicated in the foundation model's response and populates the API function with the determined value(s). If there are multiple values in the foundation model's response, the query interface preserves correct ordering of the values when populating the API function parameters.

At block 311, the query interface invokes the API function populated with the determined parameter value(s). The API function invocation comprises the parameter values determined from the user query. Population of the API function with the parameter value(s) and invocation of the API function may be part of a same operation (e.g., by passing the parameter values into the API function as part of invocation).

FIG. 4 is a flowchart of example operations for generating a response to a user query based on an API response. Generation of the response to the user query can depend on the API response size since generating summaries of larger API responses, particularly based on prompting a foundation model to summarize the large API response, can incur excessive costs and result in an excess of information being provided to the user that is not directly relevant to the user query.

At block 401, the query interface obtains the API response. The API response comprises data obtained in response to calling an API function (e.g., as described in reference to FIG. 3).

At block 402, the query interface determines a size of the API response. The query interface can determine a size of the API response based on metadata of the API response (e.g., based on a response header) or by calling a function(s) that can determine the size of the API response.

At block 403, the query interface determines if the size of the API response exceeds a threshold. The query interface has been configured with a threshold indicating a size of API responses that is too large to summarize and generate a response to the user query from directly without additional processing, as unnecessary costs may be incurred from processing the entire API response and/or the API response can include vast quantities of information that is not directly relevant to the user's query. Whether an API response size that is the same as the value indicated by the size threshold exceeds or does not exceed the threshold depends on whether the size threshold is defined as an exclusive or inclusive threshold. If the size does not exceed the threshold, operations continue at block 404. If the size exceeds the threshold, operations continue at block 405.

At block 404, the query interface generates a summary of the API response. The query interface can prompt a foundation model (e.g., an LLM) to summarize the API response in natural language. Operations continue at block 417.

At block 405, the query interface instantiates a table with a schema corresponding to the API response specification. The table can be instantiated in-memory, though implementations can instantiate an external data store (e.g., an external database). The table is instantiated with a schema according to the API response specification. For instance, the table can comprise a plurality of columns corresponding to fields of the API response that the query interface determines from the API specification and/or the API response itself.

At block 407, the query interface stores the API response in the table. The query interface writes the API response to the instantiated table. Each value included in the API response is stored in a corresponding field (e.g., column) of the table in accordance with the table schema that corresponds to the API response specification.

At block 409, the query interface generates a database query representing the user query. The database query is a query written in a database query language (e.g., SQL). The query interface can prompt a foundation model (e.g., an LLM) to generate a database query such as a SQL query representing the user query. The query interface can include in the prompt a description of the table schema and/or the API response specification obtained from API documentation to inform query generation.

At block 411, the query interface executes the database query against the table storing the API response. The query interface executes the generated database query to obtain a results set that comprises a subset of data stored in the table that satisfies the database query and therefore satisfies the user query. In this manner, data that is not relevant to the user query will not be returned as a result of executing the database query, so unnecessary information can be omitted from the response to the user query. Additionally, generating a database query and executing the database query against the table provides a level of security since the database query language is limited to performing operations on the data in the table (e.g., reading data). This is in contrast with generating code to process the data directly based on the user's query, as generating code in another language such as a high level language may be susceptible to malicious prompts resulting in malicious or otherwise unwanted code being generated and executed.

At block 413, the query interface deletes the table storing the API response. For instance, the query interface can remove the table from memory. Deleting the table from memory ensures that unnecessary costs are not incurred as a result of storing a large API response in memory.

At block 415, the query interface generates a summary of results of executing the database query. The query interface can prompt a foundation model (e.g., an LLM) to summarize the result of executing the database query in natural language.

At block 417, the query interface generates a response to the user query that comprises the generated summary. The generated response may also include the raw data obtained from calling the API (or subset of the raw data obtained based on executing the database query at block 415). The query interface communicates the generated response to the user query to fulfill the user query.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

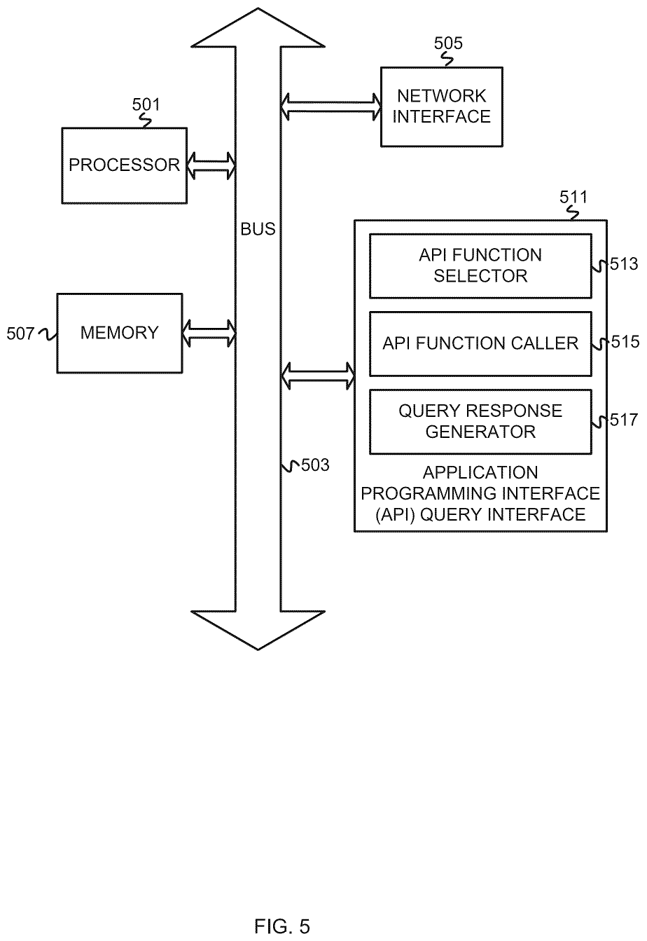

FIG. 5 depicts an example computer system with an API query interface. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes API query interface 511. The API query interface 511 responds to user queries comprising natural language based on determining an API function that most closely corresponds to a user query, creating a call to the API function based on a parameter(s) determined from the user query, and constructing a response to the user query based on a response from the API function call. The API query interface 511 comprises an API function selector 513, an API function caller 515, and a query response generator 517. The API function selector 513 selects an API function that most closely corresponds to (e.g., is most similar to) a user query. The API function caller 515 creates a call to the API function that comprises one or more parameter values determined based on the user query. The query response generator 517 generates a response to the user query based on a response to the API function call that accounts for a size of the API response. While depicted as part of the same example computer system in FIG. 5 to aid in illustration, the API function selector 513, an API function caller 515, and a query response generator 517 do not necessarily execute as part of the same computer system (e.g., can be distributed) in implementations. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A computer-implemented method comprising:
obtaining a first query comprising natural language;
determining a first application programming interface (API) call of a plurality of API calls to which the first query corresponds based at least partly on comparing an embedding of the first query and a plurality of embeddings generated from first example queries corresponding to the plurality of API calls;
populating the first API call based on determining one or more parameter values of the first API call from the first query, wherein determining the one or more parameter values comprises prompting a first language model to determine the one or more parameter values from the first query based on second example queries and corresponding parameters of the first API call that were previously determined;
issuing the first API call to obtain a response to the first API call; and
responding to the first query based on the response to the first API call.

2. The method of claim 1, wherein determining the first API call comprises, generating the embedding of the first query;
based on comparing the embedding to the plurality of embeddings, determining a subset of the plurality of embeddings to which the embedding of the first query is most similar, wherein the subset of embeddings corresponds to a subset of the plurality of API calls; and
selecting the first API call from the subset of API calls as corresponding to the first query based on prompting a second language model to select one of the subset of API calls that corresponds to the first query.

3. The method of claim 2, wherein prompting the second language model comprises prompting the second language model with the first query, descriptions of the subset of API calls, and a task instruction to determine which of the subset of API calls corresponds most closely to the first query based on their descriptions, wherein a response to prompting the second language model indicates the first API call.

4. The method of claim 1, further comprising generating a response to the first query from the response to the first API call based on a size of the response to the first API call.

5. The method of claim 4, further comprising evaluating the size of the response to the first API call based on a size threshold, wherein generating the response to the first query is based on a result of evaluating the size of the response based on the size threshold.

6. The method of claim 5, wherein generating the response to the first query comprises, based on determining that the size does not exceed the size threshold, prompting a third language model to generate a first summary of the response to the first API call and generating the response to the first query based on the first summary.

7. The method of claim 5, wherein generating the response to the first query comprises, based on determining that the size exceeds the size threshold,
storing data included in the response to the API call in a database;
generating a first database query that corresponds to the first query;
based on executing the first database query against the database, generating a second summary of results of executing the first database query; and
generating the response to the first query based on the second summary.

8. The method of claim 7, further comprising:
determining a format of the data included in the response to the API call based on a specification of the first API; and
instantiating the database with a schema that corresponds to the format of the data.

9. The method of claim 7, wherein generating the first database query comprises prompting a language model to generate a database query representing the first query based on a schema of the database.

10. One or more non-transitory machine-readable media having program code stored thereon, the program code comprising instructions to:
based on obtaining a first query comprising natural language, determine a first application programming interface (API) function of a plurality of API functions to which the first query corresponds,
wherein the instructions to determine the first API function comprise instructions to compare an embedding of the first query to a plurality of embeddings generated from first example queries and select the first API function based at least partly on a result of the comparison, wherein each of the first example queries corresponds to one of the plurality of API functions;
determine a value of a first parameter of the first API function from the first query based on prompting a first foundation model with a task instruction to extract a value of a parameter of the first API function from the first query;
populate the first API function with the value of the first parameter;
invoke the first API function to obtain an API response; and
respond to the first query based on the API response.

11. The non-transitory machine-readable media of claim 10, wherein the instructions to determine the value of the first parameter of the first API function from the first query based on prompting the first foundation model comprise instructions to prompt the first foundation model with the task instruction to extract a value of a parameter of the first API function from the first query based on second example queries and corresponding parameter values of the first API function that were previously determined.

12. The non-transitory machine-readable media of claim 10, wherein the instructions to determine the first API function comprise further instructions to:
generate the embedding of the first query;
based on comparison of the embedding to the plurality of embeddings, determine a subset of the plurality of embeddings that are most similar to the embedding of the first query, wherein the subset of embeddings corresponds to a subset of the plurality of API functions; and
select the first API function from the subset of API functions based on issuance of a prompt to a second foundation model, wherein the prompt comprises a task instruction to select one of the subset of API functions that is most related to the first query based on descriptions of each of the subset of API functions.

13. The non-transitory machine-readable media of claim 10, wherein the instructions to respond to the first query comprise instructions to, based on a determination that a size of the API response exceeds a size threshold,
store data included in the API response in a first data store, wherein the first data store comprises a database or a data structure;
generate a second query that corresponds to a database query language representation of the first query;
based on execution of the second query against the data store, generate a summary of results of execution of the second query; and
generate a response to the first query based on the summary, wherein the instructions to respond to the first query comprise instructions to respond to the first query with the generated response.

14. The non-transitory machine-readable media of claim 10, wherein the instructions to respond to the first query comprise instructions to, based on a determination that a size of the API response does not exceed a size threshold, prompt a third foundation model to generate a summary of the API response and, based on obtaining the summary of the API response, generate a response to the first query based on the summary, wherein the instructions to respond to the first query comprise instructions to respond to the first query with the generated response.

15. An apparatus comprising:
a processor; and
a machine-readable medium having instructions stored thereon that are executable by the processor to cause the apparatus to,
compare an embedding of a user query comprising natural language to a plurality of embeddings generated from first example queries, wherein each of the first example queries corresponds to one of a plurality of application programming interface (API) calls;
based at least partly on results of the comparison, select a first API call of the plurality of API calls as corresponding to the user query;
determine one or more parameter values of the first API call from the user query based on submission of a prompt to a first language model, wherein the prompt comprises a task instruction to determine the one or more parameter values from the user query based on second example queries and corresponding parameter values of the first API call that were previously determined from the second example queries;
populate the first API call with the one or more parameter values;
issue the first API call to obtain a response to the first API call; and
respond to the user query based on the response to the first API call.

16. The apparatus of claim 15, wherein the instructions executable by the processor to cause the apparatus to select the first API call comprise instructions executable by the processor to cause the apparatus to,
generate the embedding of the user query;
based on comparison of the embedding to the plurality of embeddings, determine a subset of the plurality of embeddings to which the embedding of the user query is most similar, wherein the results of the comparison indicates a subset of the plurality of API calls that correspond to the subset of embeddings; and
select the first API call from the subset of API calls based on prompting a second language model to select one of the subset of API calls that corresponds to the user query based on descriptions of each of the subset of API calls.

17. The apparatus of claim 16, wherein the instructions executable by the processor to cause the apparatus to select the first API call from the subset of API calls comprise instructions to prompt the second language model with the user query, the subset of API calls, descriptions of the subset of API calls, and a task instruction to select one of the API calls from the subset of API calls that is most similar to the user query based on the descriptions of the subset of API calls.

18. The apparatus of claim 15, further comprising instructions executable by the processor to cause the apparatus to generate a response to the user query based on evaluation of a size of the response to the API call based on a size threshold, wherein the instructions executable by the processor to cause the apparatus to respond to the user query comprise instructions executable by the processor to cause the apparatus to respond to the user query with the generated response.

19. The apparatus of claim 18, wherein the instructions executable by the processor to cause the apparatus to generate the response to the user query comprise instructions executable by the processor to cause the apparatus to, based on a determination that the size of the response to the API call satisfies the size threshold,
store data included in the response to the API call in a data store, wherein the data store comprises a database or a data structure;
generate a first query that comprises a database query language representation of the user query;
based on execution of the first query against the data store, generate a summary of results of execution of the first query; and
generate the response to the user query based on the generated summary.

20. The apparatus of claim 18, wherein the instructions executable by the processor to cause the apparatus to generate the response to the user query comprise instructions executable by the processor to cause the apparatus to, based on a determination that the size of the response to the API call does not exceed the size threshold, prompt a third language model to generate a summary of the response to the first API call and generate the response to the user query based on the generated summary.
